(19) United States
(12) Patent Application Publication
(10) Pub. No.: US 2023/0042268 A1
(43) Pub. Date: Feb. 9, 2023

(54) Double-Hinged Folding Trailer

(71) Applicant: Versatile Products, Inc., Lafayette, LA (US)

(72) Inventor: Michael Munro, Lafayette, LA (US)

(73) Assignee: Versatile Products, Inc., Lafayette, LA (US)

(21) Appl. No.: 17/395,715

(22) Filed: Aug. 6, 2021

(51) Int. Cl. B62D 63/06

(52) U.S. Cl. CPC B62D 63/061

(57) ABSTRACT

An article of manufacture for providing a double-hinged folding trailer according to the present invention is disclosed. The double-hinged folding trailer includes a front section having a first front edge and a first back edge, a center section having a second front edge and a second back edge, a rear section having a third front edge and a third back edge, a front heavy-duty hinge coupling the first back edge of the front section to the second front edge of center section, the front section pivots about the front heavy-duty hinge between a front folded upward orientation and a front unfolded downward orientation, a rear heavy-duty hinge coupling the third front edge of the rear section to the second back edge of center section, the rear section pivots about the rear heavy-duty hinge between a rear folded upward orientation and a rear unfolded downward orientation, one or more pair of wheels coupled together by a corresponding axle configured under the center section, a pair of front frame sections coupled to opposing sided of the front section, a pair of center frame sections coupled to opposing sided of the center section, and a pair of rear frame sections coupled to opposing sided of the rear section.

### TECHNICAL FIELD

This application relates in general to an article of manufacture for providing vehicle towing devices, and more specifically, to an article of manufacture providing a double-hinged folding trailer.

### BACKGROUND

Many trailer owners do not have large open areas to store their trailers when not in use, therefore, most of them store their trailers off location from where they live, and in a lot of instances, they pay a monthly fee to store said trailer(s). Most homeowners with limited storing area, generally have garages and/or small green areas. Many of those homeowners have equipment, toys and other items that require a trailer to move around, so, they actually need the trailer(s).

If a trailer can be folded and its tongue removed, in a lot of instances said trailer can be stored inside the garage, or within a very small green area, instead of being stored at a costly offsite location. Thus, the proposed folding single-axle or multi-axle trailer is herein referred to as the “folding trailer”. Prior solutions to folding trailers, due to their design, appear to cover small, single-axle trailers only. A double-hinged design that enables small or large, single or multi-axle trailers, to fold for either saving storage space or for compactness for transportation to selling sites is not found in existing solutions.

Therefore, a need exists for an article of manufacture for providing a double-hinged folding trailer. The present invention attempts to address the limitations and deficiencies in prior solutions according to the principles and example embodiments disclosed herein.

### SUMMARY

In accordance with the present invention, the above and other problems are solved by providing an article of manufacture for a double-hinged folding trailer according to the principles and example embodiments disclosed herein.

In one embodiment, the present invention is an article of manufacture for providing a double-hinged folding trailer. The double-hinged folding trailer includes a front section having a first front edge and a first back edge, a center section having a second front edge and a second back edge, a rear section having a third front edge and a third back edge, a front heavy-duty hinge coupling the first back edge of the front section to the second front edge of center section, the front section pivots about the front heavy-duty hinge between a front folded upward orientation and a front unfolded downward orientation, a rear heavy-duty hinge coupling the third front edge of the rear section to the second back edge of the center section, the rear section pivots about the rear heavy-duty hinge between a rear folded upward orientation and a rear unfolded downward orientation, one or more pair of wheels coupled together by a corresponding axle configured under the center section, a pair of front frame sections coupled to opposing sides of the front section, a pair of center frame sections coupled to opposing sides of the center section, and a pair of rear frame sections coupled to opposing sides of the rear section.

In another aspect of the present invention, a pair of removable front frame sections attachable to each side of the trailer, each of the pair of removable front frame sections are removably coupled between each of the front frame sections and the center frame section when the front section is configured in the front unfolded downward orientation.

In another aspect of the present invention, a front end of each of the removable front frame sections is secured to corresponding center frame sections by first front securing pins, and a rear end of each of the removable front frame sections is secured to corresponding rear frame sections by first rear securing pins.

In another aspect of the present invention, a pair of removable rear frame sections attachable to each side of the trailer, each of the pair of removable rear frame sections are removably coupled between each of the center frame sections and the rear frame section when the rear section is configured in the rear unfolded downward orientation.

In another aspect of the present invention, a front end of each of the removable rear frame sections is secured to corresponding center frame sections by second front securing pins, and a rear end of each of the removable front frame sections is secured to corresponding rear frame sections by second rear securing pins.

In another aspect of the present invention, the double-hinged folding trailer further includes a pair of mating receivers coupled to the front section about the first front edge for connecting a removable tongue. The removable tongue having a hitch for attaching to a towing vehicle.

In another aspect of the present invention, a pair of removable attachment support bars attaching to the pair of mating receivers after the removable tongue is disconnected from the pair of mating receivers, the attachment support bars oriented along an underside of the front section from the removable tongue at the first front edge of the front section to the second front edge of the center section.

In another aspect of the present invention, the double-hinged folding trailer further includes a cradled brace is coupled between the front frame section to the rear frame section when the front section is in the folded upward orientation and the rear section is in the folded upward orientation.

In another aspect of the present invention, the double-hinged folding trailer further includes jack rcCf{H\::l,rJc′.S coupler} to the tn-lderslde of the cerH [symbol] ⋅scctiorl, jtJ t ahead crf, a11d just behind the axle(s) for attaching jacks for supporting the trailer when in either the folded upward or unfolded downward orientation.

In another aspect of the present invention, the double-hinged folding trailer further includes a front leverage bar shaft coupled to the underside of the front section for raising the front section from the front unfolded downward orientation to the front folded upward orientation, and a rear leverage bar shaft coupled to the underside of the rear section for raising the rear section from the rear unfolded downward orientation to the rear folded upward orientation.

In another aspect of the present invention, the double-hinged folding trailer further includes a front storage space coupled to the underside of the front section along the front leverage bar shaft, and a rear storage space coupled to the underside of the rear section along the leverage bar shaft.

In another aspect of the present invention, the double-hinged folding trailer further comprises one pair of fenders coupled to the center section about the pair of wheels coupled to a single axle.

In another aspect of the present invention, the double-hinged folding trailer further comprises two pairs of fenders coupled to the center section about two pairs of wheels coupled to double axles.|

In another aspect of the present invention, the double-hinged folding trailer further comprises three pairs of fenders coupled to the center section about three pairs of wheels coupled to triple axles.|

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate various views of an example embodiment of an article of manufacture providing a double-hinged folding trailer according to the present invention.

FIG. 2 illustrates multiple views of an article of manufacture providing a double-hinged folding trailer according to the present invention.

FIG. 3 illustrates additional views of an article of manufacture providing a double-hinged folding trailer according to the present invention.

FIGS. 4a-b illustrate components of an article of manufacture providing a double-hinged folding trailer according to the present invention.

FIG. 5 illustrates a side view of a folding position of an article of manufacture providing a double-hinged folding trailer according to the present invention.

FIG. 6 illustrates a removable frame section used when an article of manufacture providing a double-hinged folding trailer is in an unfolded orientation according to the present invention.

FIGS. 7a-d illustrate multiple views of a folding position of an article of manufacture providing a double-hinged folding trailer according to the present invention.

FIGS. 8a-c illustrates various side views of a heavy duty folding trailer in an unfolded and folded position, showing optional tension cables to assist in the folding of said heavy duty trailer.

### DETAILED DESCRIPTION

This application relates in general to an article of manufacture for providing vehicle towing devices, and more specifically, to an article of manufacture providing a double-hinged folding trailer according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a double-hinged folding trailer according to the present invention. The term user herein refers to one or more users.

The term “invention” or “present invention” refers to the invention being applied for via the patent application with the title “Double-Hinged Folding Trailer.” Invention may be used interchangeably with trailer and folding trailer.

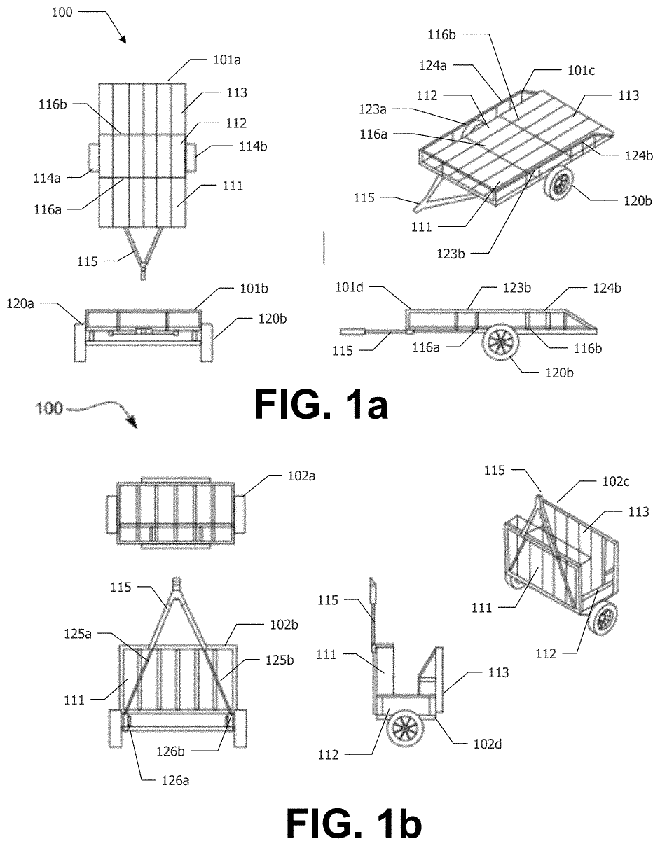

In general, the present disclosure relates to an article of manufacture providing a double-hinged folding trailer according to the present invention. To better understand the present invention, FIGS. 1a-b illustrate various views of an example embodiment of an article of manufacture providing a double-hinged folding trailer according to the present invention. FIG. 1a shows a top view 101a, front view 101b, a perspective view 101c, and a side view 101d of a double-hinged folding trailer 100 in an unfolded configuration according to the present invention. The double-hinged folding trailer 100 comprises three trailer sections: a front section 111, a center section 112, and a rear section 113. A pair offenders 114a-b is positioned on opposite sides of the center section 112 about one or more wheels 120a-b. A removable tongue 115 is coupled to a front edge of the front section 111 and a pair of attachment support bars 125a-b that run along an underside of the front section 111 from the removable tongue 115 at the front edge of the front section 111 to the center section 112. Optionally, said pair of removable attachment support bars 125a-b can be replaced with a pair of mating receivers using pins situated directly on the frame at the front of the front section 111 of the trailer 100 to receive the removable tongue at that point as referred to in later drawings. The front section 111 and the rear section 113 may be raised to a space-saving folded position using the front and rear heavy-duty hinges 116a-b.

A front heavy-duty hinge 116a couples the front and center sections together crosswise of the trailer 100. A rear heavy-duty hinge 116b couples the rear and center sections together crosswise of the trailer 100. The removable tongue 115 is shown in place when the front section 111 is raised. The removable tongue 115 couples to a pair of mating receivers 126a-b at a front end of the attachment support bars 125a-b and may be removed both before and after the front section 111 is raised. A pair of front removable frame sections 123a-b is coupled between the front section 111 and the center section 112 on each side of the trailer 100, pair of rear removable frame sections 124a-b also is coupled between the rear section 113 and the center section 112 on each side of the trailer 100. These front removable frame sections 123a-b and rear removable frame sections 124a-b are removed to permit the front section and the rear section 113 to pivot about the heavy-duty hinges 116a-b.

FIG. 1b shows a top view 102a, front view 102b, a perspective view 102c, and a side view 102d of a double-hinged folding trailer 100 in a folded configuration according to the present invention. For support, in the folded position, as can be seen in FIG. 1b, once in the folded position, optionally, a custom, cradled brace 820 can connect the front frame folded section 111, to the rear frame folded section 113 by inserting pins 821 and 822 into the pinholes 823a-b situated on said cradled brace 820 that are aligned with pinholes on 824a-b situated on front and rear folding frame sections. If no upper frame, a flat bar with pinholes aligning with the particular trailer's frame at the most efficient point will be customized to that certain type of trailer frame. Once the folded trailer is unfolded into its normal unfolded position, the front section 111 and the rear section 113 become stable, and cannot move upward due to the double pins attaching the removable frame sections 423a-b and 424a-b to the stationary frame 426. For section 111 and 113 to move upward, the removable frame sections would have to be compromised at the point of the double pins.

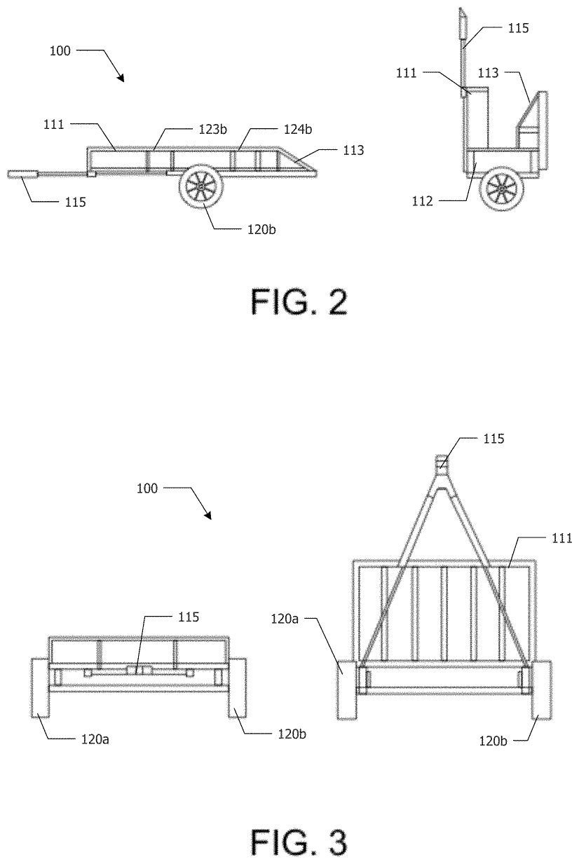

FIG. 2 illustrates side views of an article of manufacture providing a double-hinged folding trailer in both the unfolded and folded orientations according to the present invention. The trailer 100 uses the pair of front removable frame sections 123a-b and rear removable frame sections 124a-b between the front section 111 and the center section 112 and the rear section 113 and the center section 112 respectively to connect the sections 111-113 to each other when the trailer 100 is in the unfolded orientation. The front removable frame sections 123a-b and rear removable frame sections 124a-b are removed before the front section 111 and the rear section 113 may be raised by pivoting each about their respective heavy-duty hinges 116a-b.

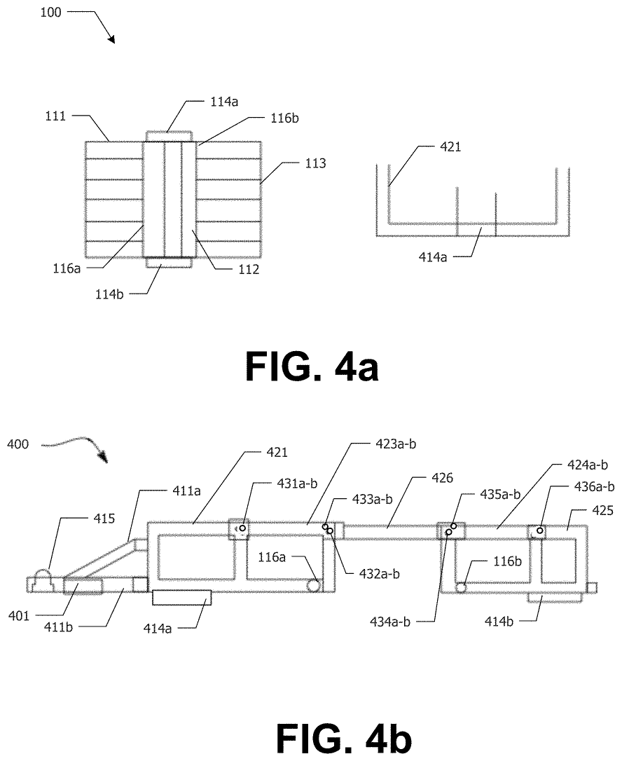

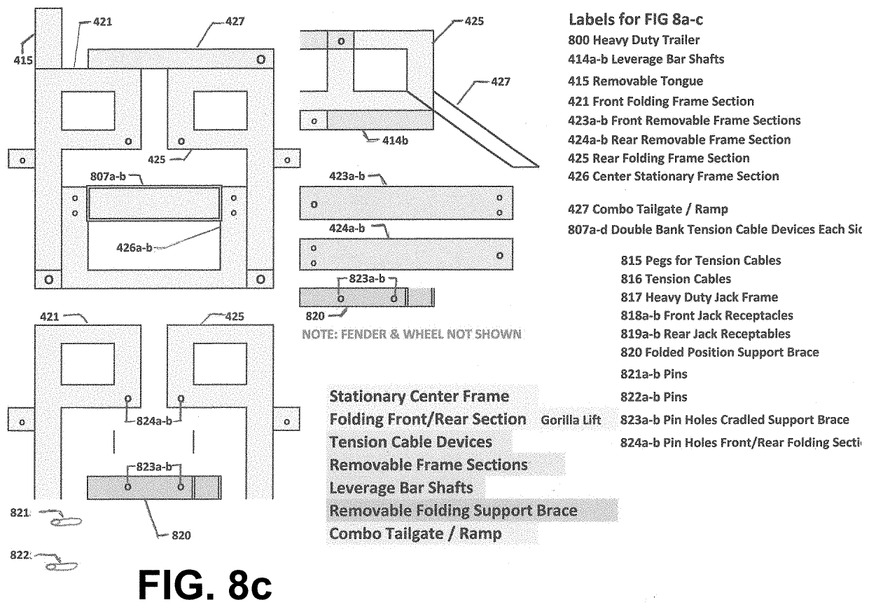

FIG. 3 illustrates front views of an article of manufacture providing a double-hinged folding trailer in both the unfolded and folded orientations according to the present invention. The jack receptacles (brackets) 412a-b are not shown in the correct place in the original drawings. Very light trailers are typically lifted under the axle or at some point on the frame near the axle. Since folding trailers have the heavy duty hinges, in order to protect them from twisting, especially for very heavy trailers, the jack receptacles, if any, are situated just ahead and just behind the axle(s) and are attached to the center frame 412, so that there is no pressure put on the heavy duty hinges. See FIG. 8a and FIG. 8b.

Additionally, trailer 100 may include control bars, inclusion of these control bars is non-essential. In some embodiments, the trailer 100 may possibly include control bars that are an extra upper part of a tongue, but for the most part, these control bars will not come into play.

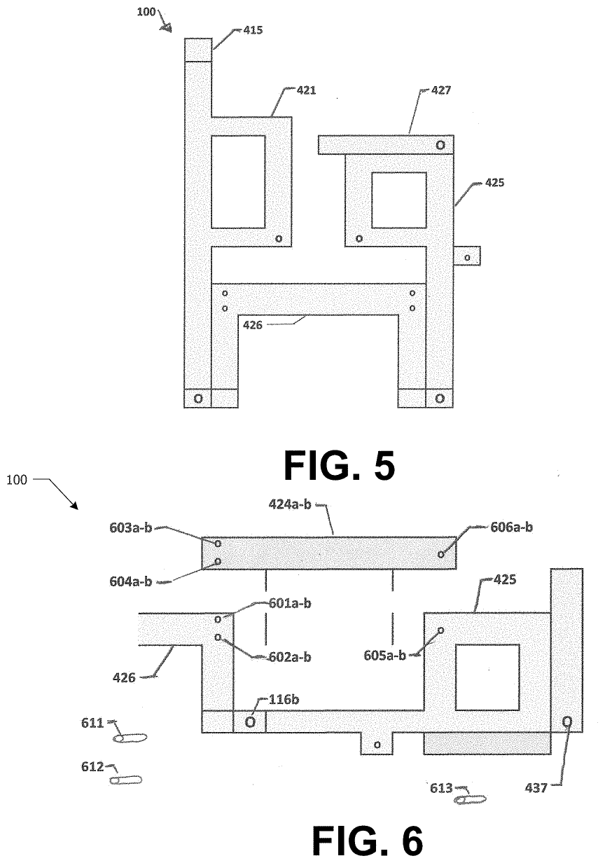

The trailer 100 may include storage space 201 on each side of each of the leverage bar shaft 414a-b under either the front section 111 and the rear section 113 as referred to in FIG. 4b and FIG. 8 below. Additionally, the trailer 100 may include taillights, turn signals, wiring, license plate, and braking connections to a towing vehicle (not shown) as required for use when the trailer 100 is unfolded and being towed.

FIGS. 4a-b illustrate components of an article of manufacture providing a double-hinged folding trailer according to the present invention. FIG. 4a shows a top view of an unfolded trailer 100 showing the front section 111, the center section 112, and the rear section 113. A pair of fenders 114a-b is shown about the wheels. The front heavy-duty hinge 116a is shown between the front section 111 and the center section 112. The rear heavy-duty hinge 116b is shown between the rear section 113 and the center section 112. The front heavy-duty hinge 116a and the rear heavy-duty hinge 116b may comprise a ratchet hinge, a crank hinge, or similar assisted-pivoting hinge that may be either manual or power operated to raise and lower the front section 111 and rear section 113 respectively. FIG. 4a also shows a front leverage bar shaft 414a coupled under a front frame section 421 that is part of the front section 111. A leverage bar (not shown) may be inserted into the leverage bar shaft 414a to permit a user to manually lift the front section 111 as it pivots about the front heavy-duty hinge 116a. An identical rear leverage bar shaft 414b is coupled to the rear frame section 425 that is part of the rear section 113 to provide the same function to the rear section 113.

FIG. 4b also shows a set of frame sections 400 comprising the front frame section 421 that is coupled the front section 111, a rear frame section 425 coupled to the rear section 113, a pair of front removable frame sections 423a-b on each side of the trailer 100, a pair of rear removable frame sections 424a-b on each side of the trailer 100, the front heavy-duty hinge 116a, the rear heavy-duty hinge 116b, a pair of center support frame members 426a-b on each side of the trailer 100, a removable tongue 401 with a hitch 415, and a combination tailgate-ramp 427. The front removable frame sections 423a-b are coupled to the front frame section 421 using single pins 431a-b on the front ends of each of the front removable frame sections 423a-b and double pins 432a-b and 433a-b on the rear ends of each of the front removable frame sections 423a-b. Similarly, the rear removable frame sections 424a-b are coupled to the rear frame section 425 using single pins 436a-b on the rear ends of each of the rear removable frame sections 424a-b and double pins 434a-b and 435a-b on the front ends of each of the rear removable frame sections 424a-b. FIG. 4b also shows front and rear leverage bar shafts 414a-b, a combination tailgate/ramp 427 and a hinge 437 for said combination tailgate/ramp.

When the pair of front removable frame sections 423a-b on each side of the trailer 100, and the pair of rear removable frame sections 424a-b on each side of the trailer 100 are removed, the front section 111 and the rear section 113 may pivot about their respective heavy-duty hinges 116a-b to configure the trailer 100 into a folded orientation. In some embodiments of the present invention, the trailer tongue may be the optional, removable locking tongue, that would be inserted into, or removed from a pair of mating receivers situated on each side, in the front and under said front frame section 421 of the trailer 100.

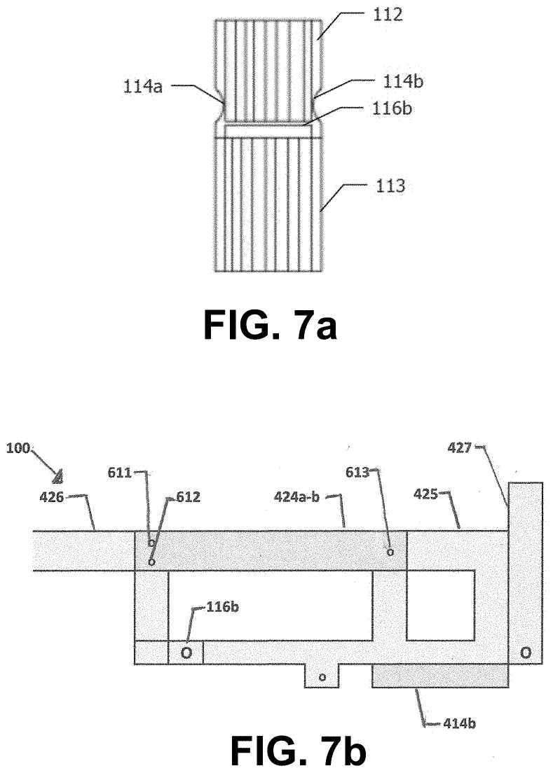

FIG. 5 illustrates a side view in a folding position of an article of manufacture providing a double-hinged folding trailer according to the present invention. FIG. 5 shows the set of frame sections 400 in their respective positions when the trailer 100 is in a folded orientation.

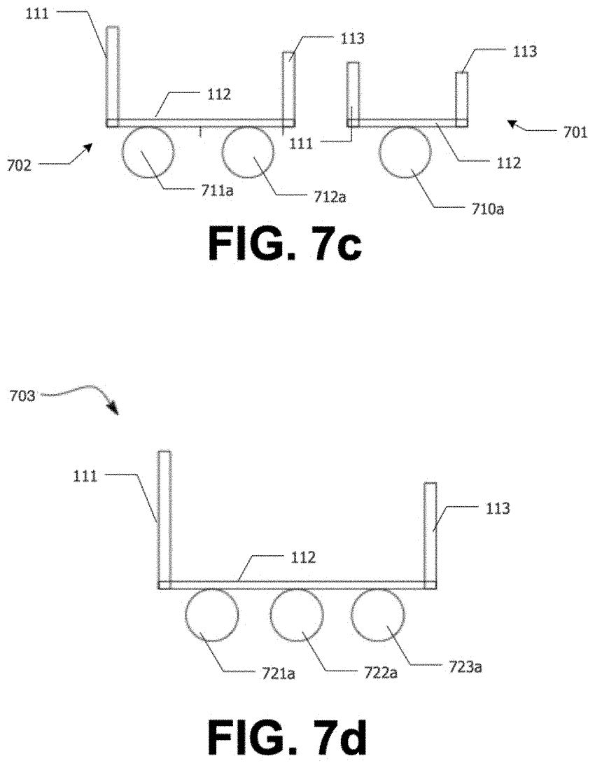

FIG. 6 illustrates a removable frame section used when an article of manufacture providing a double-hinged folding trailer is in an unfolded orientation according to the present invention. FIG. 6 shows the rear removable frame sections 424a-b on each side of the trailer 100 removed from their respective connections between the rear section frame 425 and the center section frame 426. To remove the rear removable frame sections 424a-b from each side of the trailer 100, a pair of pins 611 and 612 are removed from the front double pin holes 603a-b and 604a-b of said rear removable frame sections that are aligned and coupled with the front double pin holes 601a-b and 602a-b of the center frame section 426, and a pin 613 is removed from the rear single pin holes 606a-b of said rear removable frame section that are aligned and coupled with the rear single pin holes 605a-b of the rear frame section 425 on the respective rear removable frame section 424a-b on each side of the trailer 100. With the attachment pins 611, 612 and 613 removed, the rear removable frame sections 424a-b may be decoupled from the trailer 100. A similar arrangement exists for removal of the front removable frame sections 423a-b on each side of the trailer 100 between the front section frame 421 and the center section frame 426.

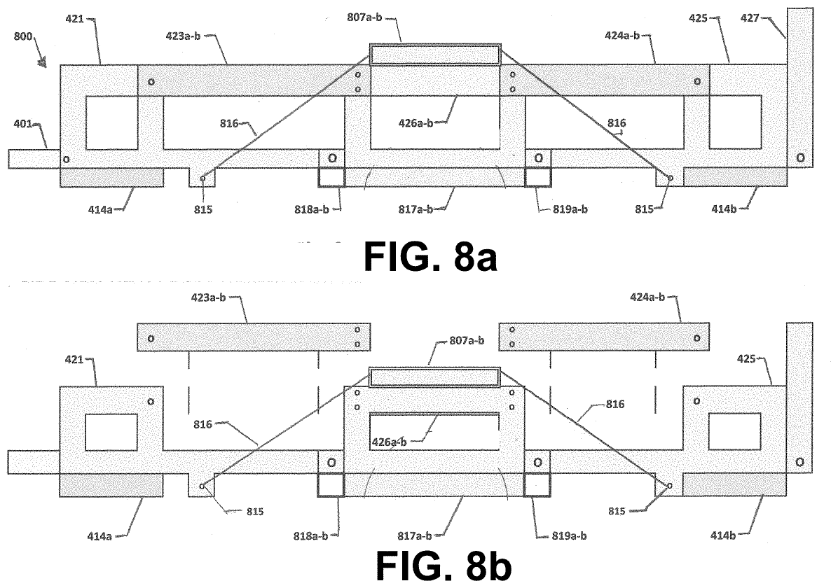

FIGS. 7a-d illustrate multiple views in a folding position of an article of manufacture providing a double-hinged folding trailer according to the present invention. FIG. 7a shows a top view of a center section 112 and a rear section 113 of the trailer 100. Fenders 114a-b are shown positioned above wheels of the trailer 100 that are coupled to the center section 112. FIG. 7b also shows rear removable frame sections 424a-b with the attachment pins 611-613 in place.

FIG. 7c shows a side view in a folding position of an article of manufacture a single axle trailer 701 having a single set of wheels 710a-b, and a side view in a folding position of a double-axle trailer 702 having a double set of wheels 711a-b and 712a-b. FIG. 7d shows a side view in a folding position of an article of manufacture providing a double-hinged folding trailer according to the present invention with triple axles and wheels 721a-b, 722a-b and 723a-b. In all of these embodiments of the trailer 100, fenders I I 4a-b over each set of wheels are attached to the center section 112 of the trailer 701-703. The axles and wheels 710a-b, 711a-b, 712a-b and 721a-b, 722a-b and 723a-b, are all located under the center section 112. The center section 112 in each of these trailers 701-703 is lengthened to permit the attachment of the number of axles and wheel pairs 710a-b, 711a-b, 712a-b, and 721a-b, 722a-b and 723a-b.

FIG. 8a-b-c illustrates side views of a heavy duty trailer 800 in the open position, which optionally can be fitted with a double bank of tension cable devices such as Gorilla Lifts 807a-b on both sides of trailer 100 to make it easy to fold the front 111 and rear 113 sections of said trailer. Said tension cable devices 807a-b are attached to the stationary center frame 426a-b, and cables 816 from said tension cable devices 807a-b stretch, and are connected to pegs 815 that are situated on the front folding section 421 and the rear folding section 425 on both sides of the trailer 100. Said tension cable devices 807a-b are attached side by side to the top member of the stationary center frame section 426a-b having an added flange on said stationary center frame section 426a-b in the center section 112 of the trailer 100 to raise or lower the front section 111 and the rear section 113. As can be also seen, there is a heavy duty jack receptacle frame 817a-b with front and rear jack receptacles 818a-b and 819a-b under the stationary center frame section 426a-b to lift any heavy loads by jack from either the front or rear of the axle. Once in the folded position, for support, as can be seen in FIG. 8c, a custom, cradled brace 820, optionally can be attached connecting the front frame folded section 111 to the rear frame folded section 113 by inserting pins 821 and 822 into pinholes 823a-b situated on said cradled brace 820, aligned with pinholes on 824a-b situated on the front folding frame section 421 and the rear folding frame section 425. If a trailer has no upper frame, optionally, a flat bar with pinholes aligning with some points on the particular trailer frame at the most efficient points will be custom made to that certain type of trailer frame. In either instance, once the folded trailer is unfolded into its normal position, the front frame section 421 and the rear frame section 425 become stable, and cannot move upward due to the double pins 432a-b, 433a-b, 434a-b and 435a-b attaching the front and rear removable frame sections 423a-b and 424a-b to the stationary center frame section 426a-b. Optional storage space can be on either, or both sides of the centered leverage bar shaft 414b shown in FIG. 8.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing a double-hinged folding trailer according to the present invention, the double-hinged folding trailer comprises:
a front section having a first front edge and a first back edge;
a center section having a second front edge and a second back edge;
a rear section having a third front edge and a third back edge;
a front heavy-duty hinge coupling the first back edge of the front section to the second front edge of center section, the front section pivots about the front heavy-duty hinge between a front folded upward orientation and a front unfolded downward orientation;
a rear heavy-duty hinge coupling the third front edge of the rear section to the second back edge of the center section, the rear section pivots about the rear heavy-duty hinge between a back folded upward orientation and a rear unfolded downward orientation;
one or more pair of wheels coupled together by a corresponding axle configured under the center section;
a pair of front frame sections coupled to opposing sides of the front section;
a pair of center frame sections coupled to opposing sides of the center section; and
a pair of rear frame sections coupled to opposing sides of the rear section.

2. The double-hinged folding trailer according to claim 1, wherein a pair of removable front frame sections attachable to each side of the trailer, each of the pair of removable front frame sections are removably coupled between each of the front frame sections and the center frame section when the front section is configured in the front unfolded downward orientation.

3. The double-hinged folding trailer according to claim 2, wherein
a front end of each of the removable front frame sections is secured to corresponding front frame sections by first front securing pins; and
a rear end of each of the removable front frame sections is secured to corresponding center frame sections by first rear securing pins.

4. The double-hinged folding trailer according to claim 1, wherein a pair of removable rear frame sections attachable to each side of the trailer, each of the pair of removable rear frame sections are removably coupled between each of the center frame sections and the rear frame section when the rear section is configured in the rear unfolded downward orientation.

5. The double-hinged folding trailer according to claim 4, wherein
a front end of each of the removable rear frame sections is secured to corresponding center frame sections by second front securing pins; and
a rear end of each of the removable front frame sections is secured to corresponding rear frame sections by second rear securing pins.

6. The double-hinged folding trailer according to claim 1, wherein the double-hinged folding trailer further comprises:
a pair of mating receivers coupled to the front section about the first front edge for connecting a removable tongue, the removable tongue having a hitch for attaching to a towing vehicle.

7. The double-hinged folding trailer according to claim 6, wherein a pair of removable attachment support bars attaching to the pair of mating receivers after the removable tongue is disconnected from the pair of mating receivers, the attachment support bars oriented along an underside of the front section from the removable tongue at the first front edge of the front section to the second front edge of the center section.

8. The double-hinged folding trailer according to claim 6, wherein the double-hinged folding trailer further comprises:
a cradled brace is coupled between the front frame section to the rear frame section when the front section is in the folded upward orientation and the rear section is in the folded upward orientation.

9. The double-hinged folding trailer according to claim 8, wherein the double-hinged folding trailer further comprises:
jack receptacles coupled to the underside of the center section, just ahead of, and just behind the axle(s) for attaching jacks for supporting the trailer when in either the folded upward or unfolded downward orientation.

10. The double-hinged folding trailer according to claim 8, wherein the double-hinged folding trailer further comprises:
a front leverage bar shaft coupled to the underside of the front section for raising the front section from the front unfolded downward orientation to the front folded upward orientation; and
a rear leverage bar shaft coupled to the underside of the rear section for raising the rear section from the rear unfolded downward orientation to the rear folded upward orientation.

11. The double-hinged folding trailer according to claim 10, wherein the double-hinged folding trailer further comprises:
a front storage space coupled to the underside of the front section along the front leverage bar shaft; and
a rear storage space coupled to the underside of the rear section along the leverage bar shaft.

12. The double-hinged folding trailer according to claim 6, wherein the double-hinged folding trailer further comprises one pair of wheels coupled to a single axle.

13. The double-hinged folding trailer according to claim 12, wherein the double-hinged folding trailer further comprises one pair of fenders coupled to the center section about the pair of wheels coupled to a single axle.

14. The double-hinged folding trailer according to claim 6, wherein the double-hinged folding trailer further comprises two pairs of wheels coupled to a double axle.

15. The double-hinged folding trailer according to claim 14, wherein the double-hinged folding trailer further comprises two pairs of fenders coupled to the center section about the two pairs of wheels coupled to a double axle.

16. The double-hinged folding trailer according to claim 6, wherein the double-hinged folding trailer further comprises three pairs of wheels coupled to a triple axle.

17. The double-hinged folding trailer according to claim 16, wherein the double-hinged folding trailer further comprises three pairs of fenders coupled to the center section about the three pairs of wheels coupled to a triple axle.
